(19) United States
(12) Patent Application Publication
(10) Pub. No.: US 2018/0010518 A1
(43) Pub. Date: Jan. 11, 2018

(54) NACELLE AND METHOD FOR INFLUENCING FLUID FLOWS IN A NACELLE

(71) Applicant: Rolls-Royce Deutschland Ltd & Co KG, Blankenfelde-Mahlow (DE)

(72) Inventor: Jens ORTMANNS, Schwielowsee / OT Caputh (DE)

(21) Appl. No.: 15/642,987

(22) Filed: Jul. 6, 2017

(30) Foreign Application Priority Data
Jul. 8, 2016 (DE) 10 2016 112 604.7

(51) Int. Cl. F02C 7/04; B64C 7/02; B64D 29/00; B64C 21/02; B64D 33/02

(52) U.S. Cl. CPC F02C 7/04; B64D 29/00; B64C 21/02; B64C 7/02; B64C 2230/22; B64D 33/02; B64D 2033/0226

(57) ABSTRACT

The invention relates to an engine nacelle, including: a nacelle wall that has an inner side and an outer side; an inlet lip that is embodied at that end of the engine nacelle that is formed upstream; and an engine intake that takes in the air required for the respective engine and that is formed by the inner side of the nacelle wall. It is provided that the nacelle wall includes an air-permeable structure that extends from the outer side to the inner side of the nacelle wall, and that is configured for passing air that flows against the outer side from the outer side to the inner side. The invention further relates to a method for influencing the flows inside an engine nacelle.

### REFERENCE TO RELATED APPLICATION

This application claims priority to German Patent Application No. 10 2016 112 604.7 filed on Jul. 8, 2016, the entirety of which is incorporated by reference herein.

### BACKGROUND

The invention relates to an engine nacelle and a method for influencing flows inside an engine nacelle.

The nacelle design for an engine is significantly impacted by the characteristics during the flight. This means that the definition of a nacelle's geometry is optimally adjusted to the flow conditions and the requirements of the fan, so that a minimal loss is created during the flight state and the specific fuel consumption is kept as low as possible.

However, there are also operational states of an engine nacelle for which the nacelle and therefore also the fan are not ideally designed. These states include the case that there is a side wind flow during the start. In the event of a side wind flow during the start, the stationary or rolling aircraft is impinged by the side wind flow, which is for example oriented perpendicularly or obliquely with respect to the start direction. Such a side wind flow can cause a flow separation at the nacelle lip, which may have a negative impact on the operational behavior of the fan. Thus, flow separations can be generated at the inlet lip if the incident intake flow is not exactly axial, as may be the case in the event of a strong side wind. As a result, disturbances of the intake flow to the engine fan are created.

EP 2 607 657 A2 describes an engine nacelle that counteracts a flow separation at the nacelle lip in the event of side wind, namely by pressurized gas extracted from the core engine being supplied to the engine intake. At that, the pressurized gas is supplied through a system of conduits of a chamber inside the nacelle that is formed in the area of the nacelle lip. From this chamber, the pressurized gas is supplied via defined openings to the engine intake.

U.S. Pat. No. 8,967,964 B2 describes an arrangement of a plurality of air discharge openings at an engine surface. In an exemplary embodiment, in order to avoid a flow separation in the event of a side wind, air discharge openings are formed in the area of the lip of an engine intake or along the circumference of the fairing of the engine intake.

The present invention is based on the objective to provide an engine nacelle and a method for influencing flows in an engine nacelle that avoid or reduce the flow separation behind the inlet lip in the event of a side wind flow.

### SUMMARY

According to an aspect of the invention an air-permeable structure is provided in the nacelle wall, with the air-permeable structure extending from the outer side to the inner side of the nacelle wall, and being configured for passing air, which is flowing against the outer side, from the outer side to the inner side. The air-permeable structure is in particular provided and configured for the purpose of making it possible for the air of a side wind flow to flow from the outer side into the nacelle directly through the nacelle wall.

Through an air-permeable structure in the nacelle wall it is achieved that air can flow into the nacelle from the outside. At that, the air flowing from the outside into the nacelle supplies energy to the particles of the boundary layer of the main flow and accelerates them, so that the boundary layer material does not come to a standstill and a separation of the boundary layer does not occur or occurs only with a delay. A flow separation behind the nacelle lip is thus delayed or even avoided. Here, the air-permeable structure is designed in such a manner that an amount of air passed is considerably smaller than the main mass flow of the air that is suctioned in by the fan of the aircraft engine.

The invention avoids a flow separation behind the nacelle lip in particular during the start. But it can also provide advantages in the case of a strong side wind flow during slow flight and cruise.

According to one embodiment of the invention, it is provided that the air-permeable structure comprises a plurality of tubes that respectively extend all the way to the inner side. According to one embodiment, the tubes extend from the outer side to the inner side. However, this is not necessarily the case. Thus, it can for example be alternatively provided that the tubes extend from a collection volume, which is formed adjacent to the outer side and takes in inflowing air from the outer side, to the inner side. It can also be alternatively provided that the tubes extend from a further structure, which is formed at the outer side of the engine nacelle and defines a preferred passing direction, as will be explained in the following.

In principle, the tubes can have any desired arrangement. For example, they can form a one-dimensional or a two-dimensional array in the nacelle wall.

In a further embodiment of the invention it is provided that the mentioned tubes are respectively embodied as a nozzle. For this purpose, they realize a cross-section reduction in the direction towards the inner side. Through the embodiment as nozzles, the velocity of the air flowing inside the tubes is increased, which leads to the boundary layer material of the main flow being more strongly accelerated, so that a flow separation is avoided in an even more effective manner.

Instead of being formed by tubes, the air-permeable structure can also be formed in a different manner. In principle, the air-permeable structure can be provided by any kind of structure, air duct and perforation that make it possible for air to be guided from the outer side to the inner side, and to flow into the nacelle. Thus, it is provided in an alternative exemplary embodiment that the air-permeable structure is formed by a porous material or comprises a porous material. In contrast, what is not considered an air-permeable structure within the meaning of the present invention is a large-area recess inside the nacelle wall that can be covered by a movable flap, where necessary; such a recess does not have its own structure.

According to one embodiment variant, the air-permeable structure is formed in such a manner that it has a defined blow-in direction from which the air can enter the structure. This can be achieved in such a manner that the air-conducting structures of the air-permeable structure transport the air that is entering at its outer side in the direction of the inner side along the preferred blow-in direction. Accordingly, the tubes or other structures that form the passage are oriented in the preferred blow-in direction adjacent to the outer side.

According to one embodiment of the invention, the defined blow-in direction extends substantially transversely to the longitudinal direction of the engine nacelle, so that the air-permeable structure provides an air permeability for a side wind component that extends substantially transversely to the longitudinal direction of the engine nacelle. If the air-permeable structure is realized by means of tubes, these extend adjacent to the outer side substantially perpendicularly to the area of the outer side where they begin. As a result, it is achieved that the air-permeable structure is permeable for a side wind component that extends substantially transversely to the longitudinal direction of the engine nacelle.

In another embodiment of the invention it is provided that the air-permeable structure is formed in such a manner that it has a defined blow-out direction in which the air flows from the inner side into the nacelle interior through corresponding openings inside the inner side.

Here, it is provided according to one embodiment of the invention that the defined blow-out direction has a directional component in the longitudinal direction of the engine nacelle, so that air flowing through the air-permeable structure flows into the nacelle interior with a speed component in the direction of the main flow. Thus, the air is deflected in the direction of the main flow, i.e. towards the fan, already inside the passage, so that it has a speed component in the longitudinal direction of the engine nacelle when it leaves the air-permeable structure. This makes it possible that the boundary layer material of the main flow more strongly accelerated by means of the air that flows through the air-permeable structure into the nacelle interior, and that flow separation effectively avoided in this way.

If the air-permeable structure is realized by means of tubes, it can be provided for this purpose that, at their ends that are facing the inner side, the tubes are curved in the longitudinal direction of the engine nacelle. In one embodiment, the tubes end at the nacelle inner wall in an approximately tangential orientation.

In another embodiment of the invention it is provided that, at the outer side, the air-permeable structure comprises at least one material layer that if formed by a porous material with a defined passing direction. Here, the material layer forms the outer shell of the engine nacelle in the respective area. By providing a defined passing direction, it is achieved that only air of a side flow can flow inside and can pass the air-permeable structure.

In one embodiment of the invention, the already mentioned tubes connect to the material layer of porous material formed with a defined passing direction at the outer side, in that case extending from this material layer to the inner side.

The air-permeable structure is formed downstream of the inlet lip, wherein it can begin directly behind the inlet lip or can alternatively be realized in an axial distance to the inlet lip. Here, the air-permeable structure extends over a defined axial length that lies between 5% and 50% of the axial length of the engine intake between the inlet lip and the fan plane, for example. Its axial distance to the nacelle lip is one to ten times, in particular twice to five times, in particular twice to three times the nacelle lip diameter, for example, wherein the nacelle lip diameter is defined as twice the radius of the upstream curvature of the nacelle lip facing the flow.

As for the extension of the air-permeable structure in the circumferential direction, it can be provided that the air-permeable structure is not formed along the entire circumference of the nacelle in the nacelle wall, but only in a certain circumferential area or in certain circumferential areas. In particular, it can be provided that the air-permeable structure is formed only in areas of the engine nacelle that are located at a side of the engine nacelle, when the engine nacelle is regarded in a state when it is mounted on a wing. What is thus regarded is a side of the engine nacelle that faces the wind if a side wind is present. However, in principle the air-permeable structure can also extend in other circumferential areas or in the entire circumferential direction.

Another aspect of the present invention relates to a method for influencing flows in an engine nacelle. It is provided in the method that, in the event of a side wind, air is guided from the outer side to the inner side through an air-permeable structure formed in the nacelle wall, and energy is thus supplied to the boundary layer of the main flow that is present at the inner side. In particular, the air flowing through the air-permeable structure accelerates the boundary layer of the main flow, so that a flow separation behind the nacelle lip, as it occurs in the event of a side wind, is reduced or avoided.

### BRIEF DESCRIPTION OF THE DRAWINGS

The invention will be explained in more detail on the basis of exemplary embodiments with reference to the accompanying drawings in which:

FIG. 1 shows a simplified schematic sectional view of a turbofan engine in which the present invention can be realized;

FIG. 2 shows, in a schematic manner, a front view into an engine nacelle according to the state of the art, also rendering a flow separation in the event of a side wind flow;

FIG. 3 shows, in a schematic manner, a partially sectioned front view of a first exemplary embodiment of the invention, wherein a side passage is formed in the nacelle wall;

FIG. 4 shows an enlarged rendering of the sectioned area A-A of FIG. 3, wherein the sectioned area is shown in front view;

FIG. 5 shows a sectional view along the line B-B of FIG. 4, wherein the sectioned area is shown in top view; and

FIG. 6 shows an alternative exemplary embodiment of the invention in a sectional view corresponding to FIG. 5.

### DETAILED DESCRIPTION

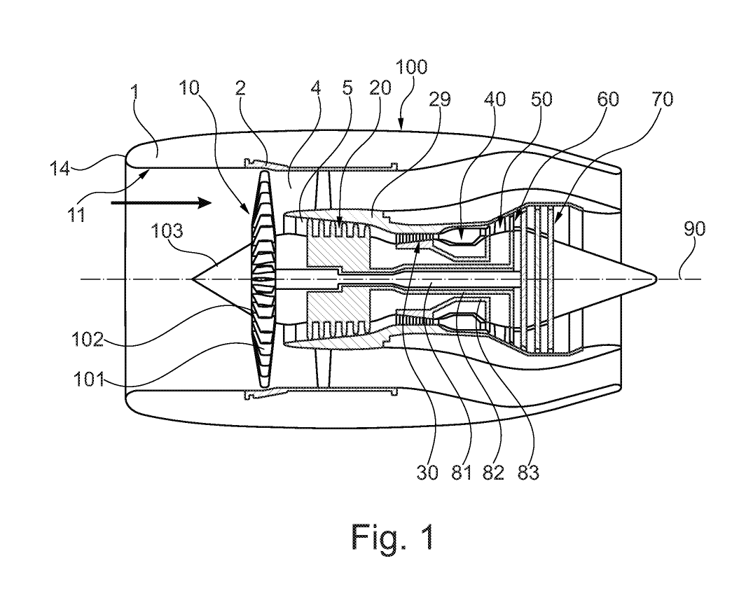

FIG. 1 shows, in a schematic manner, a turbofan engine 100 that has a fan stage with a fan 10 as the low-pressure compressor, a medium-pressure compressor 20, a high-pressure compressor 30, a combustion chamber 40, a high-pressure turbine 50, a medium-pressure turbine 60, and a low-pressure turbine 70.

The medium-pressure compressor 20 and the high-pressure compressor 30 respectively have a plurality of compressor stages that respectively comprise a rotor stage and a stator stage. The turbofan engine 100 of FIG. 1 further has three separate shafts, namely a low-pressure shaft 81 which connects the low-pressure turbine 70 to the fan 10, a medium-pressure shaft 82 which connects the medium-pressure turbine 60 to the medium-pressure compressor 20, and a high-pressure shaft 83 which connects the high-pressure turbine 50 to the high-pressure compressor 30. However, this is to be understood to be merely an example. If, for example, the turbofan engine has no medium-pressure compressor and no medium-pressure turbine, only a low-pressure shaft and a high-pressure shaft would be present.

The turbofan engine 100 has an engine nacelle 1 that has an inlet lip 14 and forms an engine inlet 11 at the entry side, supplying inflowing air to the fan 10. The fan 10 has a plurality of fan blades 101 that are connected to a fan disc 102. Here, the annulus of the fan disc 102 forms the radially inner delimitation of the flow path through the fan 10. Radially outside, the flow path is delimited by the fan housing 2. Upstream of the fan-disc 102, a nose cone 103 is arranged.

Behind the fan 10, the turbofan engine 100 forms a secondary flow channel 4 and a primary flow channel 5. The primary flow channel 5 leads through the core engine (gas turbine) which comprises the medium-pressure compressor 20, the high-pressure compressor 30, the combustion chamber 40, the high-pressure turbine 50, the medium-pressure turbine 60, and the low-pressure turbine 70. At that, the medium-pressure compressor 20 and the high-pressure compressor 30 are surrounded by a circumferential housing 29 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or by elements of the corresponding drive shaft connected to the hub.

During operation of the turbofan engine 100, a primary flow flows through the primary flow channel 5. The secondary flow channel 4, which is also referred to as the partial-flow channel, sheath flow channel, or bypass channel, guides air sucked in by the fan 10 during operation of the turbofan engine 100 past the core engine.

The described components have a common symmetry axis 90. The symmetry axis 90 defines an axial direction of the turbofan engine. A radial direction of the turbofan engine extends perpendicularly to the axial direction.

In the context of the present invention, the embodiment of the engine nacelle 1 in the axial area located upstream of the fan 10 is of particular importance.

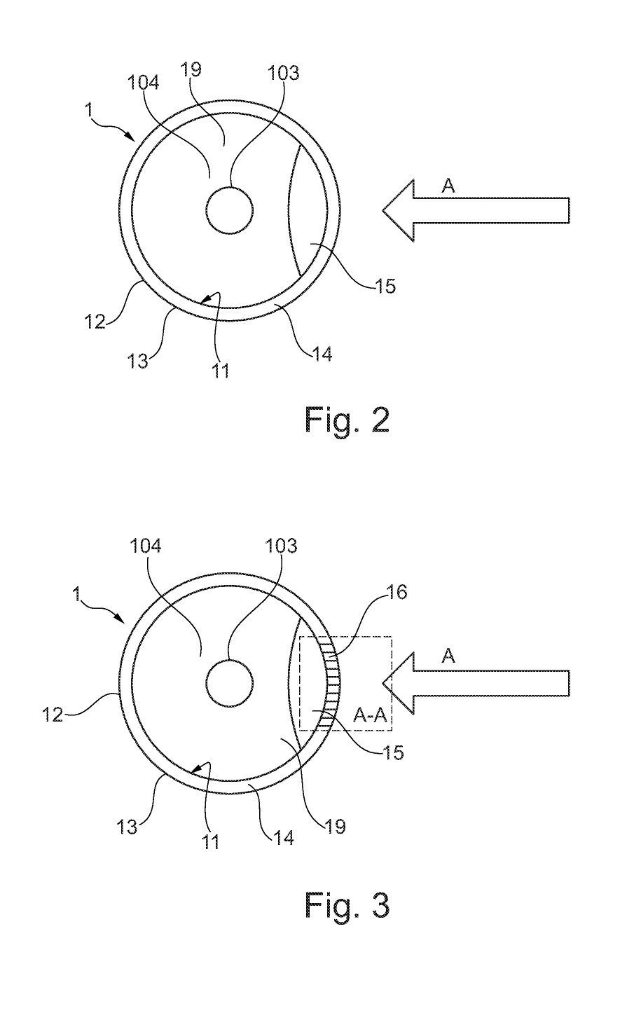

FIG. 2 shows an engine nacelle 1 in a rendering from the front, i.e. with view onto the fan. In the schematic rendering of FIG. 2, the nose cone 103 is the only part of the fan that is shown. The plane 104 represents the fan plane. The nacelle 1 has a nacelle wall 12 with an inner side 11 and an outer side 13. Here, the inner side 11 forms an engine intake in the area in front of the fan, with the engine intake taking in the air required by the engine and supplying it to the fan. The nacelle interior, i.e. the area in front of the fan that is delimited by the nacelle wall 12, is indicated by reference sign 19.

The nacelle 1 comprises an inlet lip 14 (also referred to as the nacelle lip) that is formed in a rounded manner. The inlet lip 14 forms the front end of the engine nacelle 1. At the inner side 11, it transitions into the engine intake. In the axial direction, it ends at the narrowest inner cross-section (also referred to as the “throat”) of the engine nacelle 1. In a subsonic engine intake, as it is regarded here, the engine intake 11 beginning behind the narrowest inner cross-section is embodied as a diffusor.

What is further shown in FIG. 2 is a side wind component A of a side wind flow. Due to the side wind component A, the air intake flow towards the fan does not occur in the engine intake 11 in an exactly axial manner, wherein the side wind flow additionally flows around the inlet lips 14 in the area that is facing the side wind component A. As a result, flow separations may be generated at the inlet lips 14. Such a flow separation 15 shown in a schematic manner.

FIG. 3 shows an engine nacelle 1, in which a schematically shown air-permeable structure 16 (also referred to as the passage) is formed in the nacelle wall 12, extending from the outer side 13 to the inner side 11 of the nacelle wall 12. The air-permeable structure 16 makes it possible for the air of a side wind flow A to flow from the outer side 13 directly (that is, not through the nacelle lips 14) into the nacelle interior 19. The air-permeable structure 16 extends over the defined axial length and defined angular range in the circumferential direction.

In the axial direction, the air-permeable structure 16 begins directly behind the inlet lip 14, or alternatively at a certain distance to the inlet lip 14. For example, the air-permeable structure is formed at an axial distance to the nacelle lip 14 that is twice to three times the nacelle lip diameter, wherein the nacelle lip diameter is defined as twice the radius of the upstream curvature of the nacelle lip 14 facing the flow.

As for the extension of the air-permeable structure 16 in the circumferential direction, it is provided in the shown exemplary embodiment that the air-permeable structure 16 is formed only in that area of the engine nacelle 1 that is facing towards the side wind component A. That is one of the two lateral areas when referring to the engine nacelle \ mounted on a wing. Alternatively, an air-permeable structure is formed at both side areas. However, in principle the air-permeable structure 16 can extend around the entire circumference of the nacelle 1.

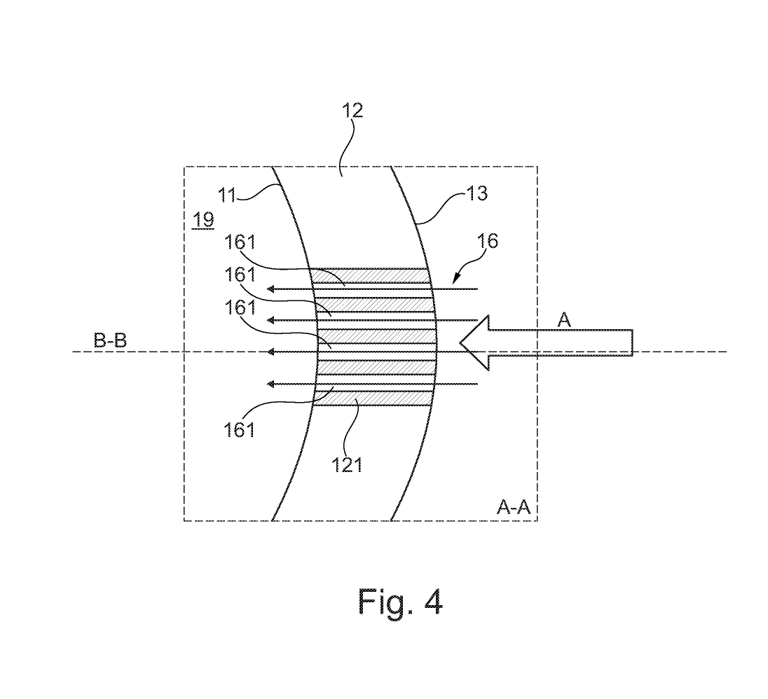

FIG. 4 shows an exemplary embodiment of an air-permeable structure 16. The air-permeable structure 16 comprises a plurality of tubes 161, which respectively extend from the outer side 13 to the inner side 11 in the shown exemplary embodiment. Here, the tubes 161 are formed in a defined area inside the nacelle wall 12 extending in the axial direction and the circumferential direction. For example, they may form a two-dimensional array in the nacelle wall 12. The tubes 161 are formed in a material 121 that forms a component of the nacelle wall 12. For example, the air-permeable structure 16 comprising the material 121 with the tubes 161 is prefabricated and inserted into a corresponding recess inside the nacelle wall 12. Alternatively, the tubes 161 are formed in a material 121 that also forms the nacelle wall 12 in other areas.

The tubes 161 have a circular cross-section, for example. However, this is not necessarily the case. For example, they may have a maximum diameter in the range between 5 mm and 10 cm. The tubes 161 end in circular holes inside the inner wall 11, for example.

The size and number of the individual tubes 161 is designed in such a manner that the total mass flow, which maximally (i.e., in the event of a strong side wind in the transverse direction) flows into the nacelle interior 19 through the air-permeable structure 16, is considerably smaller than the main mass flow that moves in the intake area 11 in the direction of the fan and flows through the fan plane 104 (cf. FIGS. 2 and 3). For example, the maximum mass flow that flows through the air-permeable structure 16 is no more than 10%, in particular no more than 5%, in particular no more than 1% of the main mass flow.

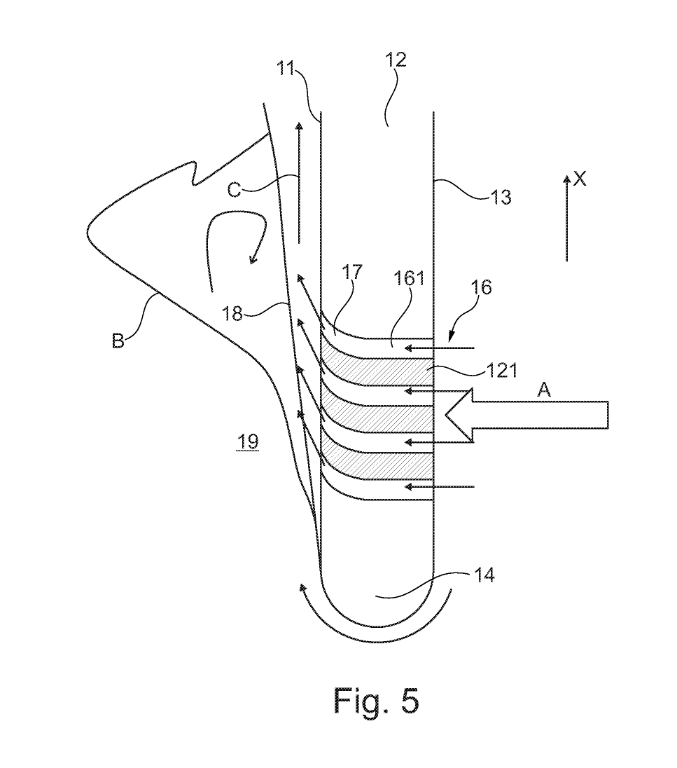

In the following, it is referred to FIG. 5, which shows a section along the line B-B of FIG. 4. The axial or longitudinal direction is indicated by X in FIG. 5. As can be seen, the individual tubes 161 are curved in the axial direction towards the inner side 11, so that the air flowing therein has a speed component in the direction of the main flow inside the engine intake 11. The air that is flowing from the tubes 161 into the engine interior 19 supplies additional energy to the air particles located in the boundary layer 18 which is present at the inner side, thus accelerating the same. This leads to a separation of the boundary layer 18, and thus a flow separation behind the inlet lip 14, being delayed or even avoided. The flow C in the boundary layer 18 is present at the inner wall 11 despite the side wind component A.

FIG. 5 also shows, in a schematic manner, the situation that would arise without the air-permeable structure 16. Here, a flow separation B would occur due to the side wind component.

As can be further seen in FIG. 5, the tubes 161 are respectively formed as a nozzle 17, and taper off in the direction of the inner wall 11 or have a tapering cross-sectional surface for that purpose. This leads to an acceleration of the air that is transported in the tubes 161. As a result, the acceleration of the air in the boundary layer 18 is even increased, so that a flow separation is avoided even more effectively.

In contrast, where they adjoin the outer side 13, the tubes 161 extend substantially transversely to the longitudinal direction X of the engine nacelle. As a result, the blow-in direction into the air-permeable structure 16 is defined transversely to the longitudinal direction X. In this way, it is ensured that a side wind component A of a side wind that is oriented transversely to the longitudinal direction X is coupled in and can be transported through the air-permeable structure 16. Due to the shape of the tubes 161 being curved towards the inner wall 11, the blow-out direction into the nacelle interior 19 that is thus defined has an axial speed component, so that the air flows into the boundary layer 18 with an axial speed component.

It is to be understood that the embodiment and arrangement of the tubes 161 in the FIGS. 4 and 5 is to be understood merely as an example. The air-permeable structure 16 can in principle also be realized by means of other structures which are suitable and provided for the purpose of transporting air from the outer side into the nacelle interior. For example, for this purpose the air-permeable structure can alternatively be formed by any material with open pores in which the individual pores are connected to each other and the environment, and in which an air-permeable structure with a defined blow-in direction and a defined blow-out direction is provided.

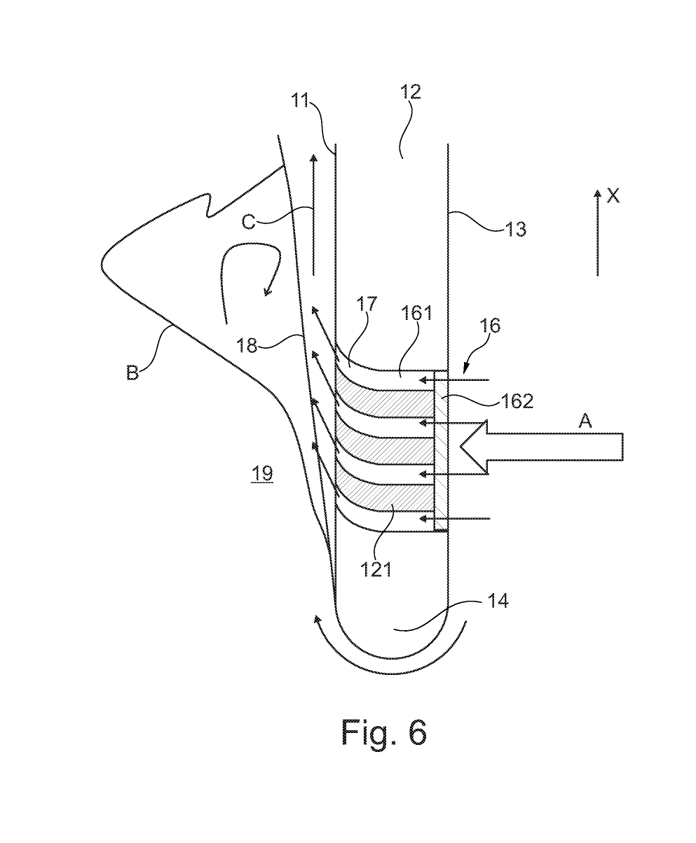

In a further embodiment variant, it is provided that an embodiment of the air-permeable structure 16 is a combination of a porous material and a plurality of tubes. Such an exemplary embodiment is shown in FIG. 6. It differs from the exemplary embodiment of FIG. 5 insofar as the air-permeable structure 16 comprises a layer 162 as a further element, which forms the passage 16 at the outer side 13 and consist of a porous material with a defined passing direction. Here, the passing direction is perpendicular to the longitudinal direction X. The layer 162 forms the outer shell of the engine nacelle 1 in the respective area.

Radially inside, a tube arrangement comprising tubes 161 connects to the layer 162 according to FIGS. 3 to 5. By using a layer 162 with a defined passing direction, it is ensured that air can flow through the air-permeable structure 16 into the nacelle interior 19 only when a side wind component A is present, while air with a different directional component cannot flow into the air-permeable structure 16.

What can be used as the porous material forming the layer 162 with a defined passing direction are air-permeable composite materials with perforations, for example. For instance, one may use air-permeable laminates that are manufactured by using blowing agents for controlled expansion of the fiber architecture. The perforation may for example be provided by pins that are contained in the composite material and that are removed after the composite material has be cured. It can also be provided that the perforation is formed by subsequent removal of sewing threads. Here, the porous material only forms the layer 162 or the outer shell, and does not extend along the tubes 161.

The present invention is not limited in its design to the above-described exemplary embodiments, which are to be understood merely as examples. For instance, it can alternatively be provided that the air inside the passage 16 is first guided into a collection volume, and is then conducted from the same into the nacelle interior via a plurality of tubes.

Further, it is to understood that the features of the individual described exemplary embodiments of the invention can be combined with each other in different combinations. As far as ranges are defined, they comprise all values within these ranges as well as all partial areas falling within a range.

1. An engine nacelle, comprising:
a nacelle wall that has an inner side and an outer side,
an inlet lip that is embodied at the end of the engine nacelle formed upstream, and
an engine intake that takes in the air required for the respective engine and that is formed by the inner side of the nacelle wall,
wherein
the nacelle wall comprises an air-permeable structure that extends from the outer side to the inner side of the nacelle wall, and that is configured for passing the air that flows against the outer side from the outer side to the inner side.

2. The engine nacelle according to claim 1, wherein the air-permeable structure comprises a plurality of tubes that respectively extend to the inner side.

3. The engine nacelle according to claim 2, wherein the tubes form a one-dimensional or a two-dimensional array.

4. The engine nacelle according to claim 2, wherein the tubes are respectively formed as a nozzle in the direction of their ends which are facing towards the inner side.

5. The engine nacelle according to claim 1, wherein the air-permeable structure is formed by a porous material or contains a porous material.

6. The engine nacelle according to claim 1, wherein the air-permeable structure is formed in such a manner that it has a defined blow-in direction.

7. The engine nacelle according to claim 6, wherein the preferred blow-in direction extends substantially transversely to the longitudinal direction of the engine nacelle.

8. The engine nacelle according to claim 2, wherein the tubes extend adjacent to the outer side substantially transversely to the longitudinal direction of the engine nacelle.

9. The engine nacelle according to claim 1, wherein the air-permeable structure is formed in such a manner that it has a defined blow-out direction.

10. The engine nacelle according to claim 9, wherein the blow-out direction has a directional component in the longitudinal direction of the engine nacelle, so that the air flowing through the air-permeable structure flows into the nacelle interior with a speed component in the direction of the main flow.

11. The engine nacelle according to claim 2, wherein the tubes are curved in the longitudinal direction of the engine nacelle at their ends that are facing towards the inner side.

12. The engine nacelle according to claim 1, wherein, at the outer side, the air-permeable structure has at least one material layer that is formed by a porous material with a defined passing direction.

13. The engine nacelle according to claim 12, wherein the plurality of tubes is formed adjacent to the material layer of porous material formed at the outer side, extending from the material layer of porous material to the inner side.

14. The engine nacelle according to claim 1, wherein the air-permeable structure is formed downstream of the inlet lip at an axial distance that is twice to five times the nacelle lip diameter.

15. The engine nacelle according to claim 1, wherein the air-permeable structure is formed at the engine nacelle at least in a circumferential area that is located at the side of an engine nacelle when the latter is mounted at a wing.

16. An engine nacelle, comprising:
a nacelle wall that has an inner side and an outer side,
an inlet lip that is embodied at the end of the engine nacelle formed upstream, and
an engine intake that takes in the air required for the respective engine and that is formed by the inner side of the nacelle wall,
wherein
the nacelle wall comprises an air-permeable structure extending from the outer side to the inner side of the nacelle wall and being configured for passing air that flows against the outer side from the outer side to the inner side,
wherein the air-permeable structure has a plurality of tubes that respectively extend to the inner side, the tubes being bent in the longitudinal direction of the engine nacelle at their ends that are facing towards the inner side and being respectively formed as a nozzle in the direction of their ends that are facing towards the inner side.

17. A turbofan engine with an engine nacelle according to claim 1.

18. A method for influencing the flows inside an engine nacelle that has a nacelle wall with an inner side and an outer side,
wherein
in the event of a side wind, air is guided from the outer side to the inner side through an air-permeable structure that is formed inside the nacelle wall, and energy is supplied to the boundary layer of the main flow that is present at the inner side.

19. The method according to claim 18, wherein the air flows into the nacelle interior with a directional component in the longitudinal direction of the engine nacelle.

20. The method according to claim 18, wherein the air is accelerated as it flows through the air-permeable structure formed in the nacelle wall.
